(19) United States
(12) Patent Application Publication
(10) Pub. No.: US 2025/0383873 A1
(43) Pub. Date: Dec. 18, 2025

(54) ADDRESS UPDATING USING STRIDE FOR PROCESSING-IN-MEMORY

(71) Applicant: Micron Technology, Inc., Boise, ID (US)

(72) Inventor: Xinyu Wu, Boise, ID (US)

(21) Appl. No.: 19/233,290

(22) Filed: Jun. 10, 2025

Related U.S. Application Data
(60) Provisional application No. 63/659,009, filed on Jun. 12, 2024.

(51) Int. Cl. G06F 9/345; G06F 9/30; G06F 9/32; G06F 12/02

(52) U.S. Cl. CPC G06F 9/3455; G06F 9/3001; G06F 9/321; G06F 12/0207

(57) ABSTRACT

An address can be updated to perform convolution operations. Updating an address can include determining, at a MAC engine coupled to an array of memory cells, a first address of first data and accessing the first data using the first address from the array. Updating the address can also include performing, at the MAC engine, a first convolution operation using the first data. Updating the address can further include determining, at the MAC engine, a second address of second data using a stride corresponding to the convolution operation and accessing the second data using the second address from the array. Updating the address can also include performing, at the MAC engine, the second convolution operation using the second data.

### PRIORITY INFORMATION

This application claims the benefit of U.S. Provisional Application No. 63/659,009, filed on Jun. 12, 2024, the contents of which are incorporated herein by reference.

### TECHNICAL FIELD

The present disclosure relates generally to memory apparatuses and methods, and more particularly to apparatuses and methods associated with updating an address using stride for processing-in-memory

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory system in accordance with a number of embodiments of the present disclosure.

FIG. 2 is a block diagram of a multiply-accumulate (MAC) unit and registers in accordance with a number of embodiments of the present disclosure.

FIG. 3 is a block diagram of a kernel and input matrix in accordance with a number of embodiments of the present disclosure.

FIG. 4 is a block diagram of a memory space in accordance with a number of embodiments of the present disclosure.

FIG. 5 illustrates an example flow diagram for updating an address using a stride for processing-in-memory in accordance with a number of embodiments of the present disclosure.

FIG. 6 illustrates an example flow diagram of a method for updating an address using a stride for processing-in-memory in accordance with a number of embodiments of the present disclosure.

### DETAILED DESCRIPTION

The present disclosure includes apparatuses and methods related to updating an address using stride for processing-in-memory (PIM). Determining an address can include determining, at a multiply-accumulate (MAC) engine coupled to an array of memory cells, a first address of first data and retrieving the first data using the first address from the array. The MAC engine can perform a first convolution operation using the first data. The MAC engine can also determine a second address of second data using a stride corresponding to the convolution operation. The MAC engine can access the second data using the second address from the array. The MAC engine can perform the second convolution operation using the second data. As used herein, a MAC engine includes hardware and/or firmware comprising one or more MAC units configured to perform operations.

A MAC engine can receive a first matrix of data values stored in a bank of memory cells of the memory system. The MAC engine can receive a second matrix of data values stored in memory system. The MAC engine can perform a plurality of operations using the first matrix and the second matrix to perform PIM. The operations performed by the MAC engine can be convolution operations. The convolution operations can be performed to implement convolution neural networks (CNN). As used herein, PIM describes the use of a memory device and/or a memory system to perform operations that could be performed in a host coupled to the memory system and/or the memory device.

However, in previous approaches the MAC engine may be unable to determine an address of different portions of the first matrix of data values if striding is used to move the second matrix along the first matrix for performing the convolution operations. Accordingly, the MAC engine may wait for an address to be provided before it can perform convolution operations. Upon completion of the convolution operations using the first matrix and the second matrix, the MAC engine can wait for an address to be provided before it can perform additional convolution operations. The addresses may be provided by a host to the MAC engine which can be inefficient.

In order to overcome these and other deficiencies of current approaches, the MAC engine can be configured to determine addresses used to retrieve the first matrix when striding is used to perform convolution operations. For example, additional registers of the memory system can store stride values, counter values, and/or threshold values to enable vertical striding and horizontal striding. The memory system can also include first adder circuitry and second adder circuitry configured to update one or more addresses stored in the MAC engine.

As used herein, artificial neural networks (ANNs) including CNNs can provide learning by forming probability weight associations between an input and an output. The probability weight associations can be provided by a plurality of nodes that comprise the ANN. The nodes together with weights, biases, and/or activation functions can be used to generate an output of the ANN based on the input to the ANN. A plurality of nodes of the ANN can be grouped to form layers of the ANN.

CNNs apply filters (e.g., kernels) to data (e.g., input matrix). The output of each convolved layer is used as the input to the next layer. The CNNs can be implemented by performing convolution operations. The convolution operations can include performing multiplication operations using the kernels and the input matrix. However, the kernel and the input matrix may have different sizes which may necessitate performing multiple multiplication operations using the kernel and different portions of the input matrix. The addresses used to access the different portions of the input matrix can be generated using two or more stride values. The stride values describe the different portions of the input matrix. For example, the stride values describe how the kernel is moved across the input matrix to perform the convolution operations. The stride value can be added to an address to define portions of the input matrix. As used herein, a portion of an input matrix is a sub-matrix of the input matrix.

As used herein, AI refers to the ability to improve an apparatus through “learning” such as by storing patterns and/or examples which can be utilized to take actions at a later time. Deep learning refers to an ability of a device to learn from data provided as examples. Deep learning can be a subset of AI. Neural networks, among other types of networks, can be classified as deep learning. Improving the efficiency at which ANNs, including CNNs, are executed can improve a function of a memory device executing the ANN and the function of the device in which the memory device is implemented. For example, improving the latency, power consumption, and/or throughput of the memory device implementing the CNN can cause an improvement to the latency, power consumption, and/or throughput of a memory system.

As used herein, a matrix is a grouping of data values organized into rows and columns where each data value has an order in a row and a column. For example, a first data value of a matrix can be a first data value in a first row and a first data value in a first column. In various instances, a matrix can be stored in a row of an array of the memory device of the memory system.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

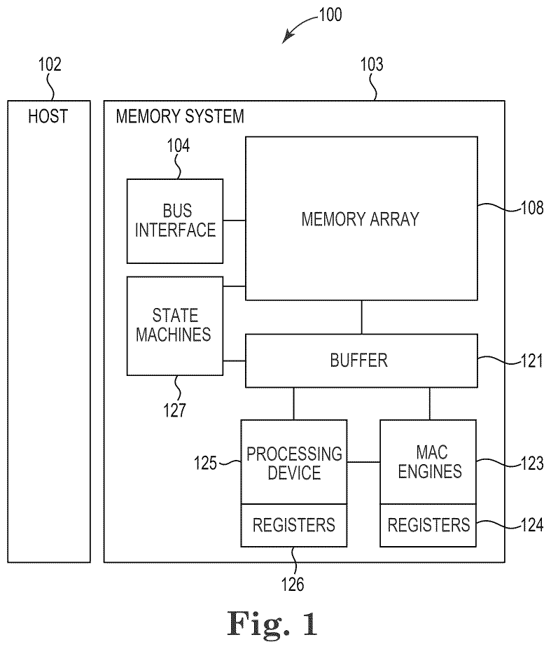

FIG. 1 is a block diagram of an apparatus in the form of a computing system 100 including a memory device 103 in accordance with a number of embodiments of the present disclosure. As used herein, a memory system 103, a memory array 108, a host 102, and a MAC engine 123 might also be separately considered an “apparatus.”

In this example, system 100 includes a host 102 coupled to the memory system 103 via an interface 104. The computing system 100 can be a personal laptop computer, a desktop computer, a digital camera, a mobile telephone, a memory card reader, or an Internet-of-Things (IoT) enabled device, among various other types of systems. Host 102 can include a number of processing resources (e.g., one or more processors, microprocessors, or some other type of controlling circuitry) capable of accessing memory system 103. The system 100 can include separate integrated circuits, or both the host 102 and the memory system 103 can be on the same integrated circuit. For example, the host 102 may be a system controller of the memory system 103, providing access to the respective memory system 103 by another processing resource such as a central processing unit (CPU).

In the example shown in FIG. 1, the host 102 is responsible for executing an operating system (OS) and/or various applications that can be loaded thereto (e.g., from memory system 103 via a controller). The host 102 can provide access commands and/or security mode initialization commands to a memory system via the interface 104.

For clarity, the system 100 has been simplified to focus on features with particular relevance to the present disclosure. The memory array 108 can be a DRAM array, SRAM array, STT RAM array, PCRAM array, TRAM array, RRAM array, NAND flash array, and/or NOR flash array, for instance. The array 108 can comprise memory cells arranged in rows coupled by access lines (which may be referred to herein as word lines or select lines) and columns coupled by sense lines (which may be referred to herein as digit lines or data lines). Although a single array 108 is shown in FIG. 1, embodiments are not so limited. For instance, the memory system 103 may include a number of arrays 108 (e.g., a number of banks of DRAM cells).

In various instances, the memory system 103 can be referred to a PIM system. The memory system 103 can include address circuitry to latch address signals provided over an interface 104. The interface can include, for example, a physical interface employing a suitable protocol (e.g., a data bus, an address bus, and a command bus, or a combined data/address/command bus). Such protocol may be custom or proprietary, or the interface 104 may employ a standardized protocol, such as Peripheral Component Interconnect Express (PCIe), Gen-Z, CCIX, or the like. Address signals are received and decoded by a row decoder and a column decoder to access the memory array 108. Data can be read from memory array 108 by sensing voltage and/or current changes on the sense lines using sensing circuitry. The sensing circuitry can comprise, for example, sense amplifiers that can read and latch a page (e.g., row) of data from the memory array 108. I/O circuitry can be used for bi-directional data communication with host 102 over the interface 104. Read/write circuitry can be used to write data to the memory array 108 or read data from the memory array 108.

Controller 125 (e.g., processing device 125) decodes signals provided by the host 102. These signals can include chip enable signals, write enable signals, and address latch signals that are used to control operations performed on the memory array 108, including data read, data write, and data erase operations. In various embodiments, the controller 125 is responsible for executing instructions from the host 102. The controller 125 can comprise a state machine 127, a sequencer, and/or some other type of control circuitry, which may be implemented in the form of hardware, firmware, or software, or any combination of the three.

In various instances, the controller 125 can receive signals provided by the host 108 including signals requesting operations to be performed by MAC engines 123. For example, the controller 125 can provide a signal requesting that a convolution operation be performed to the MAC engines 123. The controller 125 can receive the signal from the host 102 and can cause an input matrix of data values and a kernel of data values to be read from the memory array 108 and provided to the MAC engines 123. As used herein, the MAC engines 123 can include hardware, firmware, and/or software for performing operations using data provided by the memory array 108. For example, the MAC engines 123 can perform convolution operations. The MAC engines 123 can perform a convolution operation using an input matrix and a kernel. The convolution operation can include performing multiplication operations using the kernel and different portions of the input matrix. As used herein, a data value is a number that can be used to perform operations such as multiplication operations.

In various instances, the MAC engine 123 can utilize I/O lines to receive the input matrix of data values and the kernel of data values and to provide a result matrix of data values. The result matrix of data values can be stored back to the memory array 108 and/or can be provided to the host 102.

In various examples, the MAC engines 123 can receive a sub-matrix of the input matrix of data values and the kernel of data values from the memory array 108 to perform the convolution operation.

In various instances, the controller 125 can cause data values of the input matrix received from the host 102 to be organized and stored in the memory array 108 such that the matrix is stores in memory cells coupled to a same word line. Storing the memory array 108 in memory cells coupled to a same word line allows for addresses used to retrieve portions of the input matrix to be updated using a stride value. The registers 124 can store the stride values and can store counter values that are used to determine which of the stride values to add to an address used to retrieve a portion of the input matrix. As used herein, a portion of the input matrix is a sub-matrix of the input matrix. The portion of the input matrix can have an address which can be used to retrieve the portion of the input matrix. The controller 125 can include registers 126 which are used to store commands provided by the host 102. For example, the controller 125 can store commands that indicate that convolution operations are to be performed by the MAC engines 123.

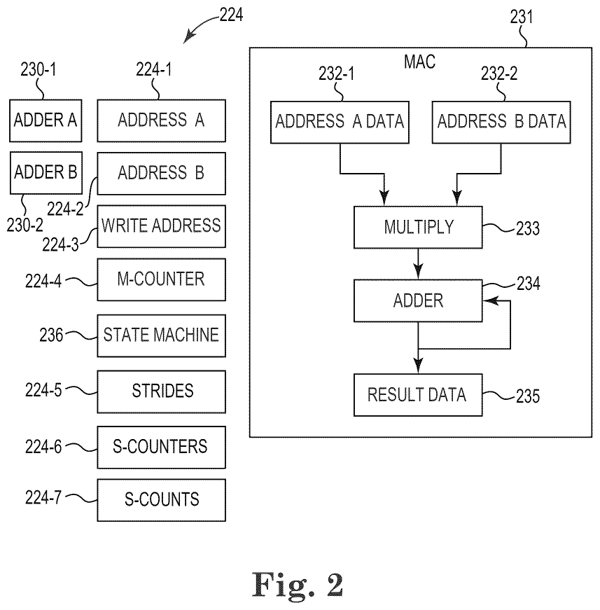

FIG. 2 is a block diagram of a MAC unit 231 and registers 224 in accordance with a number of embodiments of the present disclosure. The MAC unit 231 can be part of the MAC engine of a PIM system. For example, the MAC engine can include multiple of the MAC unit 231. The MAC unit 231 receives data 232-1, 232-2. The MAC unit 231 includes multiplication circuitry 233 and adder circuitry 234. The MAC unit 231 outputs result data 235. The MAC engine can also include adder circuitry 230-1 and adder circuitry 230-2.

The registers 224 include registers 224-1, 224-2, 224-3, 224-4, 224-5, 224-6, 224-7. The registers 224-1, 224-2 can store a first address and a second address, respectively. The first address corresponds to the data 232-1 and the second address corresponds to the data 232-2. For example, the data 232-1 is stored in memory cells of the memory array having a first address. The data 232-2 is stored in memory cells of the memory array having the second address.

The register 224-3 stores a write address of memory cells of the memory array that are configured to store the result data 235. The registers 224-4 stores an m-counter value. The m-counter value is a length of the dataset. The dataset is the input matrix used to perform the convolution operation using the MAC unit 231.

The MAC engine can also include a state machine 236. The state machine 236 updates and loads data stored in memory cells having the first address and the second address stored in the registers 224-1, 224-2, respectively.

The register 224-5 stores a first stride value and a second stride value. The register 224-6 stores a first s-counter value and a second s-counter value. The register 224-7 stores a count value. The count value is a threshold.

The state machine 236 can use the adder circuitry 230-1 to add the stride values to the first address stored in the register 224-1. The state machine 236 can also use the adder circuitry 230-2 to add stride values to the second address stored in the registers 224-1.

The data 232-1 can be a portion of the input matrix. The data 232-2 can be a kernel or a portion of the kernel. In various examples, the data 232-1 can be a data value of a portion of the input matrix. The data 232-2 can be a data value of a kernel.

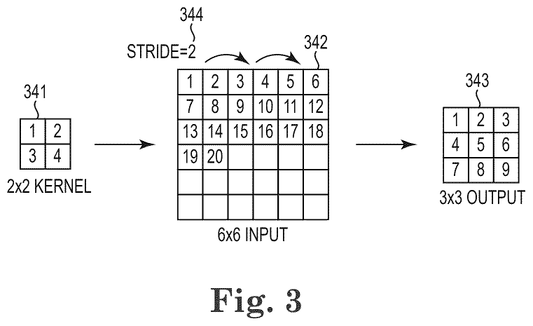

The state machine 236 can utilize the stride values stored in the registers 224-5 to update the addresses stored in the registers 224-1, 224-2 using the adder circuitry 230-1, 230-2. The example of FIG. 3 shows the use of a stride value for determining an address corresponding to a portion of the input matrix. In previous approaches, the state machine 236 would simply add one to the first address or the second address. However, with convolution operations the addresses may need to be updated by adding values other than a one value to the addresses.

The host can cause the stride values to be stored in the registers 224-5, the counter values to be stored in the registers 224-6, and the count values in the registers 224-7 of the PIM system. After which, the MAC engine may update the addresses without requiring that the host provide updated addresses. Updating addresses locally to the MAC engine can speed up the duration of time used to perform the convolution operations as compared to waiting for the addresses to be updated from a source external to the MAC engine. The convolution operations can be performed using the MAC unit 231.

FIG. 3 is a block diagram of a kernel 341 and an input matrix 342 in accordance with a number of embodiments of the present disclosure. The kernel 341 can be a 2×2 matrix. The input matrix 342 can be a 6×6 matrix. The output matrix 343, also referred to as a result matrix, can be a 3×3 matrix.

The output matrix 343 can be generated using the MAC unit 231 of FIG. 2. The convolution operations performed to generate the output matrix 343 can perform multiplication operations using the kernel 341 and portions of the input matrix 342. For instance, a first convolution operation can multiply the data values of the kernel 341 with the data values of a portion of the input matrix 342. The data values of a portion of the input matrix 342 are shown as data values 1, 2, 7, and 8. The data values of the kernel 341 are shown as data values 1, 2, 3, 4. The data values of the output matrix 343 are shown as data values 1, 2, 3, 4, 5, 6, 7, 8, 9.

The first convolution operation can multiply the data values of the kernel 341 with the data values 1, 2, 7, 8 of the first portion of the input matrix 342. For example, the data value 1 of the kernel 341 can be multiplied with the data value 1 of the first portion of the input matrix 342. The data value 2 of the kernel 341 can be multiplied with the data value 2 of the first portion of the input matrix 342. The data value 3 of the kernel 341 can be multiplied with the data value 7 of the first portion of the input matrix 342. The data value 4 of the kernel 341 can be multiplied with the data value 8 of the first portion of the input matrix 342. The result of the multiplication operations can be summed to generate the data value 1 of the output matrix 343.

The convolution operations described in FIG. 3 are configured using a stride 344 having a value of 2. The second convolution operation can receive an address of the data value 3 indicating that the data values 3, 4, 9, 10 are to be used in the second convolution operation. The data values 3, 4, 9, 10 of the second portion of the input matrix 342 can be multiplied with the data values 1, 2, 3, 4 of the kernel 341. The output of the multiplication operations can be summed to generate the data value 2 of the output matrix 343.

The third convolution operation can receive an address of the data value 5 indicating that the data values 5, 6, 11, 12 are to be used in the third convolution operation. The data values 5, 6, 11, 12 of the third portion of the input matrix 342 can be multiplied with the data values 1, 2, 3, 4 of the kernel 341. The output of the multiplication operations can be summed to generate the data value 3 of the output matrix 343.

The fourth convolution operation can receive the address of the data value 13 by which it can be seen that two stride values can be utilized to perform the convolution operations. A first stride value (e.g., 2) can be used to select data values of the input matrix 342 that are organized in a row of the input matrix 342. For example, the data values 1, 3, 5 can be selected for performance of convolution operations. The distance between the data values 1, 3, 5 is two which is the stride value 344 (e.g., stride=2). The second stride value (e.g., 8) can be used to select data values of the input matrix 342 that are organized in different rows of the input matrix 342. For example, going from the data value 5 to data value 13 has a distance of 8 data values which is the second stride value. The second stride value can be utilized to select a data value (e.g., data value 13) of a next row starting from a last data value (e.g., data value 5) of a previous row of the input matrix 342. The first stride value can be used to select values horizontally relative to the input matrix 342. The second stride value can be used to select values vertically relative to the input matrix 342.

In various examples, the data values of a portion of the input matrix 342 can be accessed from the memory array utilizing an address of a single data value. For example, the data values 1, 2, 7, 8, can be accessed from the memory array utilizing the address of the data value 1. It may only be necessary to update a single address to traverse the input matrix 342.

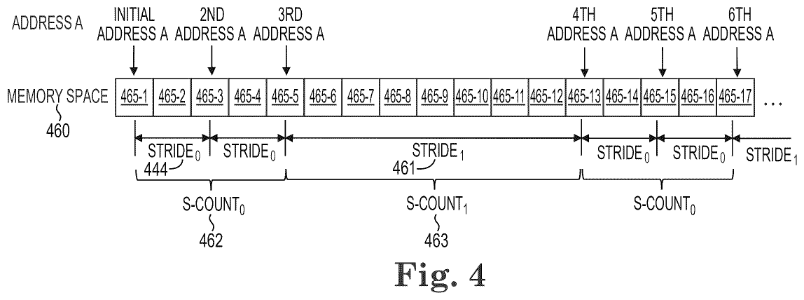

FIG. 4 is a block diagram of a memory space 460 in accordance with a number of embodiments of the present disclosure. The memory space 460 includes memory cells having memory addresses 465-1, 465-2, 465-3, 465-4, 465-5, 465-6, 465-7, 465-8, 465-9, 465-10, 465-11, 465-12, 465-13, 465-14, 465-15, 465-16, 465-17, referred to as addresses 465.

The memory space 460 can store an input matrix and/or a kernel. For example, the memory space 460 can store the input matrix 342 of FIG. 3. The data values 1, 2, 3, 4, 5, 6, 7, 8, 9, 10, 11, 12, 13, of FIG. 3 can be stored in the memory cells having the addresses 465. For instance, the data value 1 can be stored in memory cells having the address 465-1. The data value 2 can be stored in memory cells having the address 465-2. The data value 3 can be stored in memory cells having the address 465-3. The data value 4 can be stored in memory cells having the address 465-4. The data value 5 can be stored in memory cells having the address 465-5. The data value 6 can be stored in memory cells having the address 465-6.

The data value 7 can be stored in memory cells having the address 465-7. The data value 8 can be stored in memory cells having the address 465-8. The data value 9 can be stored in memory cells having the address 465-9. The data value 10 can be stored in memory cells having the address 465-10. The data value 11 can be stored in memory cells having the address 465-11. The data value 12 can be stored in memory cells having the address 465-12. The data value 13 can be stored in memory cells having the address 465-13, etc.

The address 465-1 can be utilized to access data values stored in the memory cells having addresses 465-1, 465-2, 465-7, 465-8. The address 465-3 can be utilized to access data values stored in memory cells having addresses 465-3, 465-4, 465-9, 465-10. The address 465-5 can be utilized to access data values stored in memory cells having addresses 465-5, 465-6, 465-11, 465-12. The address 465-13 can be utilized to access data values stored in memory cells having addresses 465-13, 465-14, 465-19, 465-20.

The data values stored in the memory cells having addresses 465-1, 465-2, 465-7, 465-8 can comprise the first portion of the input matrix. The data values stored in memory cells having addresses 465-3, 465-4, 465-9, 465-10 can comprise a second portion of the input matrix. The data values stored in memory cells having addresses 465-5, 465-6, 465-11, 465-12 can comprise a third portion of the input matrix. The data values stored in memory cells having addresses 465-13, 465-14, 465-19, 465-20 can comprise a fourth portion of the input matrix. Each of the first portion, the second portion, the third portion, and the fourth portion can be sub-matrices of the input matrix. Each of the sub-matrices can have a same number of columns and rows as the kernel. For instance, each of the sub-matrices are 2×2 matrices while the kernel is also a 2×2 matrix.

After performing a convolution operation using the data values retrieved using the address 465-1 and the kernel, a stride value 444 (e.g., Stride.) can be used to update an address 465-1 to generate the address 465-3. Given that there are two addresses between the address 465-1 and the address 465-3, the stride value 444 can have a value of two. After performing a convolution operation using the data values retrieved using the address 465-3 and the kernel, the stride value 444 can be used to update an address 465-3 to generate the address 465-5.

After performing a convolution operation using the data values retrieved using the address 465-5 and the kernel, a stride value 461 (e.g., Stride₁) can be used to update an address 465-5 to generate the address 465-13. Given that there are eight addresses between the address 465-5 and the address 465-13, the stride value 461 can have a value of eight. The stride value 461 can be utilized to update the address 465-5 given that the end of a row of the input matrix has been reached. To isolate a different sub-matrix from the input matrix, data values of a different row (e.g., third row of the input matrix of FIG. 3) of the input matrix can be utilized. The different row can be different as compared to the row of the input matrix that includes the data values having the addresses 465-1, 465-3, 465-5.

A first counter value can be utilized to determine when an end of a row of an input matrix has been reached. A first count value (e.g., S—count₀) can be a threshold against which the first counter is compared to determine when an end of a row of an input matrix has been reached. A second counter value can be utilized to determine when a next row of an input matrix has been reached. A second count value (e.g., S—count₁) can be a threshold against which the second counter is compared to when a next row of an input matrix has been reached.

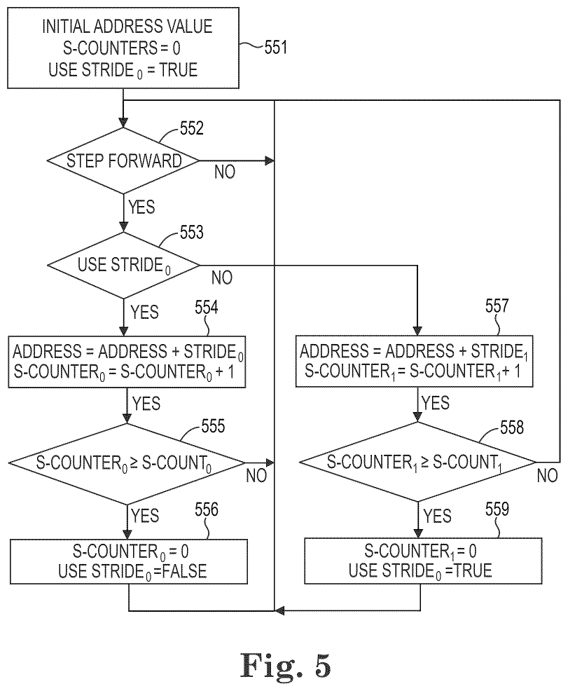

For example, the first count value can be utilized to determine that the address 465-5 has been reached after a first portion of the input matrix has been utilized to perform the first convolution operation. The second count value can be utilized to determine that the address 465-13 has been reached after a third portion of the input matrix has been utilized to perform the third convolution operation. FIG. 5 provides an example for utilizing the stride values, the counter values, and the count values to update addresses for performing convolution operations.

FIG. 5 illustrates an example flow diagram for updating an address using a stride for PIM in accordance with a number of embodiments of the present disclosure. At 551, an initial address value can be received, a first counter (e.g., S—Counter₀) can be reset, and a stride determination value (e.g., Stride₀) can be set to “True.”

The initial address value can be received from a host. For example, a controller of the memory system can receive the initial address value. The controller of the memory system can provide the initial address value to the MAC engine. The MAC engine can store the initial address value. The MAC engine can access data values of the input matrix from the memory array of the memory system. The MAC engine can provide the data values to the MAC units. The MAC units can perform a convolution operation utilizing the data values of the input matrix and a kernel. The addresses corresponding to memory cells that store the kernel are not shown in the example of FIG. 5 given that the example centers around updating addresses used to access data values of the input matrix.

A convolution operation can be performed by the MAC units using data values stored at memory cells having the initial address value prior to resetting the first counter or after resetting the first counter. In various instances, an updated address can be determined based on performing a first convolution operation. The updated address can be determined in preparation for performing a second convolution operation.

At 552, a determination can be made as to whether to continue to update the initial address and/or a previously updated address. Responsive to determining not the continue to update addresses a loop can be established and the determination can be continually made until a determination to continue to update addresses is made. The determination to update addresses can be provided via a value. The value can be stored in a register of the MAC engine. Setting a value to “1” can cause the state machine of the MAC engine to initiate the method of FIG. 5. Setting a value to “0” can cause the state machine to not execute the method of FIG. 5 until the value is set to “1” again.

At 553, a determination can be made as to whether the stride determination value is set to “Yes”. If the stride determination value is set to “No,” the method can continue to 557. If the stride determination value is set to “Yes,” the method can continue to 554. The stride determination can indicate whether a first stride value is used to update the initial address value or a second stride value is used to update the initial address value. Th stride determination can also indicate whether to traverse the input matrix vertically or horizontally. As used herein, the terms vertically and horizontally as used to describe an orientation of the data values of the input matrix and are not meant to limit the traversal of the input matrix. For example, if the stride determination value is set to “Yes” the input matrix can be traversed horizontally along a row of the input matrix. If the stride determination value is set to “No” the input matrix can be traversed vertically from a row of the input matrix to a different row of the input matrix.

Given that the stride determination value was initiated to a “True” values, the method can continue to 554. At 554, the initial address can be updated by adding the first stride value to the initial address. For example, if the initial address is address 465-1 as provided by FIG. 4, then the initial address can be updated to address 465-3 as provided by FIG. 4 because the address 465-1 plus the first stride value equals the address 465-3. The first counter value can be updated by incrementing the first counter value. Incrementing the counter value can include adding a constant to the first counter value. In this case, the counter value is updated by adding a one to the counter value.

Responsive to updating the address, the controller of the MAC engine can utilize the updated address to access the next portion of the input matrix. The next portion of the input address can be provided to the MAC unit for performing a convolution operation.

Responsive to updating the address and/or the first counter value, the method can continue to 555. At 555, the determination can be made as to whether the first counter value is equal to or greater than a first count value, the first count value being a first threshold. If the first counter value is equal to or greater than the first threshold, the method can continue to 556. If the first counter is not equal to or greater than the first threshold, the method can continue to 552.

If the first counter value is initiated to have a 0-value, then the first count value (e.g., first threshold) can have a 2-value. The first counter value can indicate that the input matrix has been traversed to the end of a row of the input matrix. In this case, the first counter value can have a value of 1 after being incremented which results in the counter value not being greater than the first threshold.

After the first counter value has a value of 2, the first counter can be reset and the stride determination value can be set to “False”. Responsive to resetting the first counter value and/or setting the stride determination value to “False”, the method can return to 552. Resetting the first counter and setting the stride determination value to “False” can indicate that the input matrix has been traversed to the end of a row of the input matrix. For example, the updated address can have a value of address 465-5 of FIG. 5.

At 552, given that the input matrix is still being traversed, a determination can be made that go to 553. At 553, a determination can be made that the stride determination value is equal to “False” (e.g., no). The method can continue to 557. The right side of the flow chart can correspond to traversing the input matrix vertically while the left side of the flow chart corresponds to traversing the input matrix horizontally.

At 557, the address can be updated by adding a second stride value to the address (e.g., previously updated address). For example, the 8-value (e.g., the second stride value) can be added to the address. The updated address can have a value of address 456-13 as provided in FIG. 4. At 557, the second counter value can be incremented. For example, the second counter value can be incremented from a 0-value to a 1-value. The second count value can also be equal to 1 in this case. However, the second count value can be equal to a different value. Responsive to incrementing the address at 557, the updated address can be utilized to perform a next convolution operation.

At 558, a determination can be made as to whether the second counter value is equal to or greater than the second count value. If the second counter value is not greater than or equal to the second count value, then the method can continue to 552. If the second counter value is greater than or equal to the second count value, the method can continue to 559.

At 559, the second counter value can be reset and the stride determination value can be set to “True”. The method can again return to 552. The second stride value can provide an address of memory cells storing a data value (e.g., data value stored in memory cells having address 465-13) corresponding to a different row of the input matrix than the row of a previous data value (e.g., data value stored in memory cells having address 465-5). Once the input matrix has been traversed to a next row, the input matrix can continue to be traversed horizontally again. Responsive to concluding the performance of the convolution operations, a value of the MAC engine can be set to “0” to cause the state machine to not execute the method at 552.

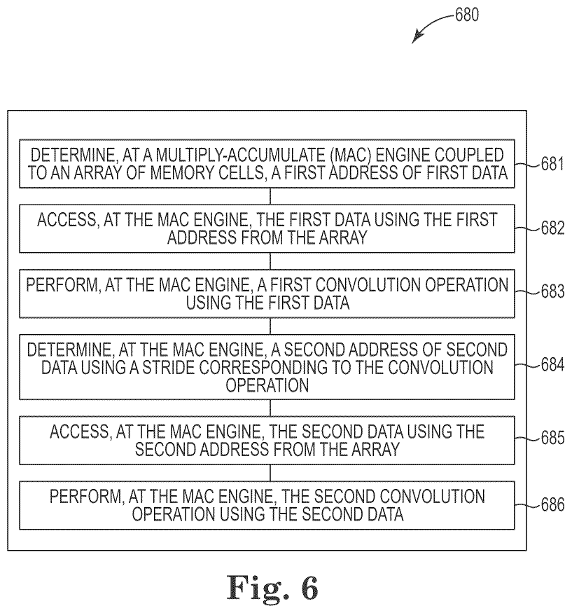

FIG. 6 illustrates an example flow diagram of a method 680 for updating an address using a stride for PIM in accordance with a number of embodiments of the present disclosure. The method can be executed by a memory system of a computing system.

At 681, a MAC engine 123 of FIG. 1 coupled to an array 108 of the memory cells can determine a first address of first data. The first address of the first data can be an address of memory cells that store the first data. The MAC engine can determine the first address, for example, by receiving the first address from a host 102 of FIG. 1. The first data can include a data value and/or multiple data values of an input matrix.

At 682, the MAC engine can access the first data using the first address from the array. For example, the MAC engine can cause memory cells having the first address to be sensed. The first data can be provided to the MAC engine after being sensed. The MAC engine can utilize the first data and data of a kernel to perform a number of operations such as convolution operations.

At 683, the MAC engine can perform a first convolution operation using the first data. For example, the MAC engine can utilize the first data and data of a kernel to perform a number of operations such as convolution operations.

At 684, the MAC engine can determine a second address of second data using a stride corresponding to the convolution operation. For example, the MAC engine can determine the second address using a first stride value or a second stride value. The first stride value can be used to increase the second address along a row of the input matrix while the second stride value can be used to increase the second address from a first row of the input matrix to a second row of the input matrix.

At 685, the MAC engine can access the second data using the second address from the array. At 686, the MAC engine can perform the second convolution operation using the second data.

The MAC engine can determine the second address by determining whether to use the stride. For example, the MAC engine can determine whether to use a first stride value or a second stride value. If the next data value is included in a same row of the input matrix as a previous data value, then the first stride value can be utilized. If the next data value is included in a different row of the input matrix as a previous data value, then the second stride value can be utilized.

Responsive to determining to use the stride (e.g., the first stride value), the address can be updated by adding the stride to the address. For example, the first stride value can be added to the address to add the address. The updated address can be utilized to access a next portion of the input matrix.

Responsive to updating the address, the updated address can be provided for us in the convolution operation. For example, the updated address can be utilized to access the data. The data can be utilized to perform a convolution operation using a MAC unit of the MAC engine.

Responsive to determining to use the stride (e.g., the first stride value), a row counter (e.g., first counter) can be updated by incrementing the row counter. The row counter can be used to traverse a row of the input matrix.

Responsive to updating the row counter, a determination can be made as to whether the row counter is greater than a row threshold. The row threshold can correspond to the row counter. The row threshold can be provided by a host prior to performing the convolution operations. The row threshold can be utilized to determine when the input matrix has been traversed to the end of a row of the input matrix.

Responsive to determining that the row counter is greater than the row threshold, the row counter can be reset, an indication to not use the stride can be stored, and a determination as to whether to use the stride can be made. The indication to not use the stride can be provided as an indication to use the second stride value. The indication can be stored in registers of the MAC engine.

Responsive to determining that the row counter is not greater than the row threshold, a determination can be made as to whether to use the stride. That is, the method can repeat itself.

In various examples, an apparatus can comprise an array of memory cells, addition circuitry, and a MAC engine. The addition circuitry can increment an address of the array based on a stride (e.g., stride value) of a convolution operation. The MAC engine can be coupled to the array. In various examples, the MAC engine can include the addition circuitry. The MAC engine can determine an address of data using the addition circuitry. For example, the MAC engine can add a stride value to the address using the addition circuitry. The MAC engine can access the data using the address from the array. The MAC engine can perform the convolution operation using the data.

The MAC engine configured to determine the address is further configured to determine whether to use a different stride for the convolution operation. The different stride can be a first stride value used to traverse the input matrix along a row of the input matrix. The stride can be a second stride value used to traverse the input matrix from a first row to a second row of the input matrix.

Responsive to determining not to use the different stride, the MAC engine can update the address by adding the stride to the address using the addition circuitry. The MAC engine can provide the updated address for use in the convolution operation. The MAC engine can also, responsive to determining not to use the different stride, updating a column counter by incrementing the column counter.

The MAC engine can include a first register to store the column counter. A row counter can correspond to the different stride while a column counter corresponds to the stride. A second register can store the row counter.

The MAC engine can, responsive to incrementing the column counter, determine whether the column counter is greater than a column threshold. The MAC engine can include a third register configured to store the column threshold. The column counter and the column threshold can be utilized to identify a data value of a row of the input matrix that is different from the row of a previous data value.

The MAC engine can, responsive to determining that the column counter is greater than the column threshold, reset the row counter. Responsive to determining that the column counter is greater than the column threshold, the MAC engine can store an indication to use the different stride. The MAC engine can also determine whether to use the different stride using the indication. Storing the indication to use the different stride can indicate that a data value of a next row of the input matrix has been identified using an updated address and that the next traversal of the input matrix is along a row of the input matrix and not from a first row of the input matrix to a second row of the input matrix.

The MAC engine can, responsive to determining that the column counter is not greater than the column threshold, determine whether to use the different stride. An additional iteration of the updating of the address can be performed responsive to determining that the column counter is not greater than the column threshold.

In various examples, an apparatus can comprise an array of memory cells, first addition circuitry, second addition circuitry, and a MAC engine. The first addition circuitry can increment an address of the array based on a first stride of a convolution operation. The second addition circuitry can increment the address of the array based on a second stride of the convolution operation. Although the first addition circuitry and the second addition circuitry are not described as being internal to the MAC engine, the first addition circuitry and the second addition circuitry can be internal to the MAC engine.

The MAC engine can determine a first address of first data using the first addition circuitry. The first address can be updated by adding a first stride value to a previous address. The MAC engine can access the first data using the first address from the array. The MAC engine can also perform a first convolution operation using the first data. The MAC engine can determine a second address of second data using the second addition circuitry. The MAC engine can update the second address by adding a second stride value to the first address. The MAC engine can access the second data using the second address from the array. The MAC engine can perform a second convolution operation using the second data.

In various examples, the first stride indicates a movement of the kernel across a row of the input data. For example, portions of an input matrix that are aligned along a row of the input matrix can be selected using the first stride value. Movement of the kernel can reference that the portions of the input matrix that are aligned along a row of the input matrix are multiplied with the kernel.

The second stride (e.g., second stride value) can indicate a movement of the kernel across multiple rows of the input data. For example, a portion of an input matrix that is aligned along a second row of the input matrix where a previous portion of the input matrix is aligned along a first row of the input matrix can be selected using the second stride value. Movement of the kernel can reference that the portions of the input matrix that are aligned along the second row of the input matrix is multiplied with the kernel.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
determining, at a multiply-accumulate (MAC) engine coupled to an array of memory cells, a first address of first data;
accessing, at the MAC engine, the first data using the first address from the array;
performing, at the MAC engine, a first convolution operation using the first data;
determining, at the MAC engine, a second address of second data using a stride corresponding to the convolution operation;
accessing, at the MAC engine, the second data using the second address from the array; and
performing, at the MAC engine, the second convolution operation using the second data.

2. The method of claim 1, further comprising determining whether to use the stride prior to determining the second.

3. The method of claim 2, further comprising, responsive to determining to use the stride, updating the address by adding the stride to the address.

4. The method of claim 3, responsive to updating the address, providing the updated address for use in the convolution operation.

5. The method of claim 2, further comprising, responsive to determining to use the stride, updating a row counter by incrementing the row counter.

6. The method of claim 5, further comprising, responsive to updating the row counter, determining whether the row counter is greater than a row threshold.

7. The method of claim 6, responsive to determining that the row counter is greater than the row threshold:
resetting the row counter;
storing an indication to not use the stride; and
determining whether to use the stride.

8. The method of claim 6, responsive to determining that the row counter is not greater than the row threshold, determining whether to use the stride.

9. An apparatus, comprising:
an array of memory cells;
a multiply-accumulate (MAC) engine, coupled to the array and comprising addition circuitry for incrementing an address of the array based on a stride of a convolution operation;
wherein the MAC engine is configured to:
determine an address of data using the addition circuitry;
access the data using the address from the array; and
perform the convolution operation using the data.

10. The apparatus of claim 9, wherein the MAC engine configured to determine the address is further configured to determine whether to use a different stride for the convolution operation.

11. The apparatus of claim 10, wherein the MAC engine is further configured to, responsive to determining not to use the different stride:
update the address by adding the stride to the address using the addition circuitry; and
provide the updated address for use in the convolution operation.

12. The apparatus of claim 10, wherein the MAC engine is further configured to, responsive to determining not to use the different stride, updating a column counter by incrementing the column counter.

13. The apparatus of claim 12, further comprising a first register configured to store the column counter.

14. The apparatus of claim 12, wherein the MAC engine is further configured to, responsive to incrementing the column counter, determine whether the column counter is greater than a column threshold.

15. The apparatus of claim 14, further comprising a second register configured to store the column threshold.

16. The apparatus of claim 14, wherein the MAC engine is further configured to, responsive to determining that the column counter is greater than the column threshold:
reset the column counter;
store an indication to use the different stride; and
determine whether to use the different stride.

17. The apparatus of claim 14, wherein the MAC engine is further configured to, responsive to determining that the column counter is not greater than the column threshold determine whether to use the different stride.

18. An apparatus, comprising:
an array of memory cells;
first addition circuitry for incrementing an address of the array based on a first stride of a convolution operation;
second addition circuitry for incrementing the address of the array based on a second stride of the convolution operation;
a multiply-accumulate (MAC) engine, coupled to the array and configured to:
determine a first address of first data using the first addition circuitry;
access the first data using the first address from the array;
perform a first convolution operation using the first data;
determine a second address of second data using the second addition circuitry;
access the second data using the second address from the array; and
perform a second convolution operation using the second data.

19. The apparatus of claim 18, wherein the first stride indicates a movement of a kernel across a row of input data.

20. The apparatus of claim 18, wherein the second stride indicates a movement of a kernel across multiple rows of input data.
